(19) United States
(12) Patent Application Publication
(10) Pub. No.: US 2011/0316891 A1
(43) Pub. Date: Dec. 29, 2011

(54) METHOD OF DRIVING DISPLAY ELEMENT AND DISPLAY DEVICE

(75) Inventor: Hirokata UEHARA, Kawasaki (JP)

(73) Assignee: FUJITSU LIMITED, Kawasaki (JP)

(21) Appl. No.: 13/036,519

(22) Filed: Feb. 28, 2011

(30) Foreign Application Priority Data
Jun. 23, 2010 (JP) 2010-142860

(51) Int. Cl. G09G 5/10; G09G 3/36

(52) U.S. Cl. 345/690; 345/89

(57) ABSTRACT

A display device includes a display element and a drive circuit that drives the display element, in which the drive circuit outputs a reset pulse that changes an orientation state of liquid crystal into a first orientation state, a selection pulse that changes the first orientation state into a second orientation state by combinations of a plurality of pulses in accordance with gradation data of an image to be displayed, and a maintenance pulse that maintains the second orientation state.

### CROSS-REFERENCE TO RELATED APPLICATIONS

This application is based upon and claims the benefit of priority of the prior Japanese Patent Application No. 2010-142860, filed on Jun. 23, 2010, the entire contents of which are incorporated herein by reference.

### FIELD

The embodiments discussed herein are related to a method of driving a display element and a display device.

### BACKGROUND

As a display device, one using liquid crystal, such as electronic paper, is being developed. For example, a display element using cholesteric liquid crystal may take on a planar state where light having a specific wavelength is reflected, a focal conic state where light is transmitted, and an intermediate state between the planar state and the focal conic state by adjusting the intensity of an electric field to be applied and an image is displayed by setting the liquid crystal of each pixel into any of these states.

As a method of driving a display device using liquid crystal, for example, a dynamic drive system (DDS) is used. By using the DDS, it is possible to rewrite a high-contrast image at high speed.

The drive period of the DDS is roughly divided into three stages, that is, from the beginning, a preparation period, a selection period, and an evolution period. Before and after the preparation period, the selection period, and the evolution period, a non-select period is provided.

The preparation period is a period during which liquid crystal is initialized into a homeotropic state. During the preparation period, a plurality of preparation pulses of a comparatively high voltage is applied.

The selection period is a period during which branching of the final state into the planar state (bright state: white display) or the focal conic state (dark state: black display) is triggered. During the selection period, the homeotropic state is formed almost completely when the state is switched into the planar state finally or a transient planar state when the state is switched into the focal conic state. During the selection period, a relatively high voltage pulse is applied when switching the state into the planar state or a relatively low voltage pulse is applied when switching into the focal conic state.

During the evolution period, following the change into the transient state during the immediately previous selection period, the planar state or the focal conic state is settled. During the evolution period, a plurality of evolution pulses of an intermediate voltage between that of the preparation pulse and that of the selection pulse is applied.

### Related Documents

[Patent Document 1] Japanese Laid-open Patent Publication No. H11-326871
[Patent Document 2] Japanese Laid-open Patent Publication No. 2008-268566
[Patent Document 3] Japanese Laid-open Patent Publication No. 2007-128043
[Patent Document 4] Japanese Laid-open Patent Publication No. 2004-205705
[Patent Document 5] Japanese Laid-open Patent Publication No. 2001-329256
[Patent Document 6] U.S. Pat. No. 5,453,863
[Patent Document 7] U.S. Pat. No. 6,154,190
[Patent Document 8] U.S. Pat. No. 6,982,691
[Non-Patent Document 1] J. Ruth, et. al.: “LOW COST DYNAMIC DRIVE SCHEME FOR REFLECTIVE BISTABLE CHOLESTERIC LIQUID CRYSTAL DISPLAYS”, Flat Panel Display '97.
[Non-Patent Document 2] Nam-Seok Lee and Woon-Seop Choi, Displays 25 (2004) 201-205)
[Non-Patent Document 3] X. Y. Huang, et. al.: “Gray Scale of Bistable Reflective Cholesteric Displays”, SID 98 DIGEST

### SUMMARY

According to an aspect of the embodiments, a method of driving a display element includes the steps of: changing an orientation state of liquid crystal into a first orientation state; changing the first orientation state into a second orientation state by combinations of a plurality of pulses in accordance with gradation data of an image to be displayed; and maintaining the second orientation state.

According to an another aspect of the embodiments, a display device includes: a display element; and a drive circuit that drives the display element, wherein the drive circuit outputs: a reset pulse that changes an orientation state of liquid crystal into a first orientation state; a selection pulse that changes the first orientation state into a second orientation state by combinations of a plurality of pulses in accordance with gradation data of an image to be displayed; and a maintenance pulse that maintains the second orientation state.

The object and advantages of the embodiments will be realized and attained by means of the elements and combination particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIGS. 1A to 1D are diagrams illustrating voltage response characteristics of cholesteric liquid crystal;

FIG. 2A is a diagram explaining state transition in a conventional drive system;

FIG. 2B is a diagram explaining state transition in a dynamic drive system;

FIGS. 3A and 3B are diagrams illustrating waveforms applied in a dynamic drive system;

FIGS. 4A to 4C are diagrams explaining a scan operation in a dynamic drive system;

FIGS. 5A and 5B are diagrams illustrating a distribution of voltage waveforms applied to each pixel when an image is written by a dynamic drive system;

FIG. 6 is a diagram specifically illustrating voltage waveforms applied to liquid crystal molecules;

FIGS. 7A to 7C are diagrams illustrating examples in which a voltage signal applied during the selection period, that is, a selection pulse is changed when producing a display of an intermediate gradation by a dynamic drive system;

FIGS. 8A and 8B are diagrams illustrating a change in display value and on-duty to obtain an intermediate gradation when the on-duty during the selection period is changed;

FIG. 9 is a block diagram illustrating a configuration of a cholesteric liquid crystal display device in a first embodiment;

FIG. 10 is a diagram illustrating a configuration of a display element 10 used in the first embodiment;

FIG. 11 is a diagram illustrating a basic configuration of one panel 10A;

FIG. 12A is a diagram illustrating a configuration of a segment driver;

FIG. 12B is a diagram illustrating a configuration of a common driver;

FIG. 13 is a diagram illustrating drive waveforms output from the common driver during the preparation period, the selection period, the evolution period, and the non-select period, drive waveforms output from the segment driver when ON and OFF, and waveforms applied to liquid crystal in the first embodiment;

FIG. 14 is a diagram illustrating configurations of parts corresponding to a voltage data/LCD voltage conversion circuit in the common driver and a one-scan electrode of the output driver;

FIG. 15 is a diagram illustrating configurations of pulses applied to each pixel during the selection period in the first embodiment;

FIG. 16 is a diagram illustrating reflection characteristics of a display when 16 kinds of voltage waveform are applied during the selection period in the first embodiment;

FIG. 17 is a diagram illustrating configurations of pulses applied to each pixel during the selection period in a second embodiment;

FIG. 18 is a diagram illustrating configurations of pulses applied to each pixel during the selection period in a third embodiment.

### DESCRIPTION OF EMBODIMENTS

Embodiments are explained below with reference to the drawings. However, the technical scope of the present invention is not limited to these embodiments and the items described in the claims and their equivalents are also included.

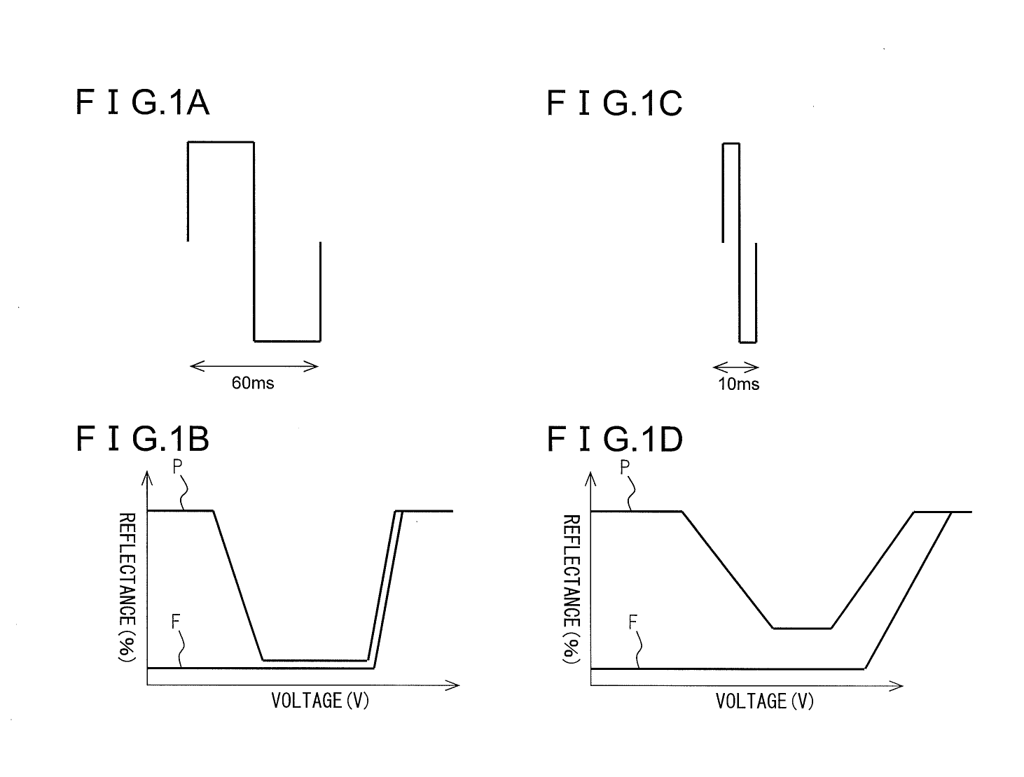

FIGS. 1A to 1D are diagrams illustrating voltage response characteristics of cholesteric liquid crystal, wherein FIGS. 1A and 1B illustrate characteristics when a pulse of 60 ms is applied and FIGS. 1C and 1D illustrate characteristics when a pulse of 10 ms is applied. In general, a set of positive and negative pulses is applied when a voltage is applied to liquid crystal in order to prevent polarization of the liquid crystal. In the following explanation, a set of positive and negative pulses is generally referred to as a pulse and the period of the sum of the periods of the set of positive and negative pulses as a pulse width in some cases.

As illustrated in FIGS. 1A to 1D, when the initial state is the planar state as represented by line P, when a pulse voltage is raised to a certain range, a drive band to the focal conic state is brought about and when the pulse voltage is further raised, a drive band back to the planar state is brought about. As represented by line F, when the initial state is the focal conic state, as the pulse voltage is raised, a drive band to the planar state is gradually brought about.

When a pulse having a narrow pulse width is applied, energy given is low, and therefore, the amount of change is lower compared to the case where a pulse having a great pulse width is applied and the voltage characteristics shift toward the side of high voltages.

The method of driving a cholesteric liquid crystal display device is roughly divided into a conventional drive system and a dynamic drive system.

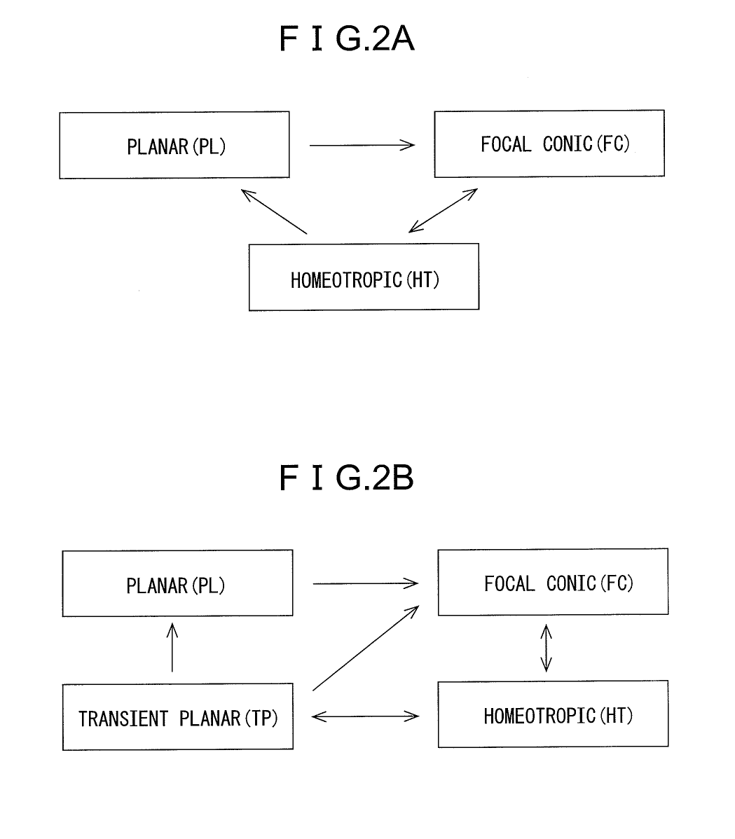

FIGS. 2A and 2B are diagrams explaining the state transition in the conventional drive system and the dynamic drive system, wherein FIG. 2A illustrates the state transition in the conventional drive system and FIG. 2B illustrates the state transition in the dynamic drive system.

As illustrated in FIG. 2A, in the conventional drive system, the transition between the three states, that is, the planar state (PL), the focal conic state (FC), and the homeotropic state (HT) described above is controlled by the pulse wave height and pulse width according to the characteristics in FIGS. 1A to 1D. The transition to the focal conic state requires a long time, and therefore, an increase in display speed is a general problem.

As illustrated in FIG. 2B, the dynamic drive system uses a transient planar state (TP) in addition to the three states described above. In the transient planar state, as in the planar state, the helical axis of liquid crystal is oriented in the direction perpendicular to the substrate (electrode), however, the pitch of the helical axis is about twice that of the planar state. The transient planar state changes into the focal conic state when an electric filed of predetermined intensity is applied.

The dynamic drive system is a system in which whether the final state is the planar state or the focal conic state is set for each line using the parts of the slant lines on the right of the voltage response characteristics in FIG. 1 and processing advances to that of the next line before the state of the line is settled. The time required for the setting of each line is about 1 ms and this setting is performed in a pipeline manner, and therefore, when the number of lines of the display panel is 1,000, rewrite may be done in about one second.

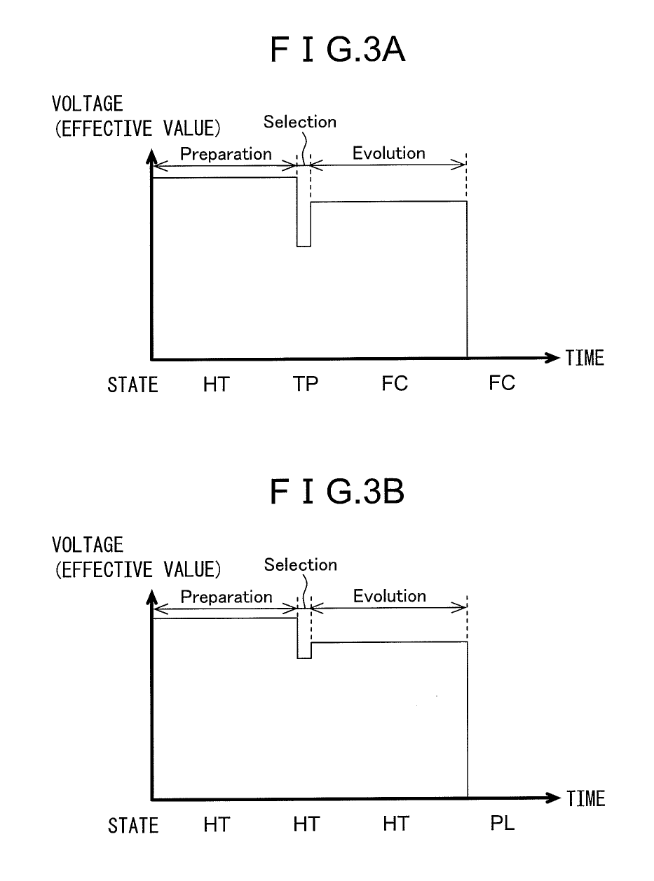

FIGS. 3A and 3B are diagrams illustrating waveforms applied in the dynamic drive system, wherein FIG. 3A illustrates a waveform to turn a pixel into a black pixel and FIG. 3B illustrates a waveform to turn a pixel into a white pixel.

As illustrated in FIGS. 3A and 3B, the waveform applied in the dynamic drive system includes the preparation period, the selection period, and the evolution period.

During the preparation period, a voltage corresponding to the homeotropic state is applied to a liquid crystal. After that, by applying a pulse of a low voltage during the short selection period, whether the homeotropic state is maintained or the state is relaxed into the transient planar state is set. After that, during the evolution period, a voltage suitable for the transition from the planar state to the focal conic state is applied. The pixel in the homeotropic state maintains this state during the evolution period and when the evolution period ends, the state transitions to the planar state. The pixel in the transient planar state transitions to the focal conic state during the evolution period. During the selection period, only whether to transition to the planar state or the focal conic state is set, and therefore, the setting may be done in a very short time. Because of this, a high-speed display may be achieved.

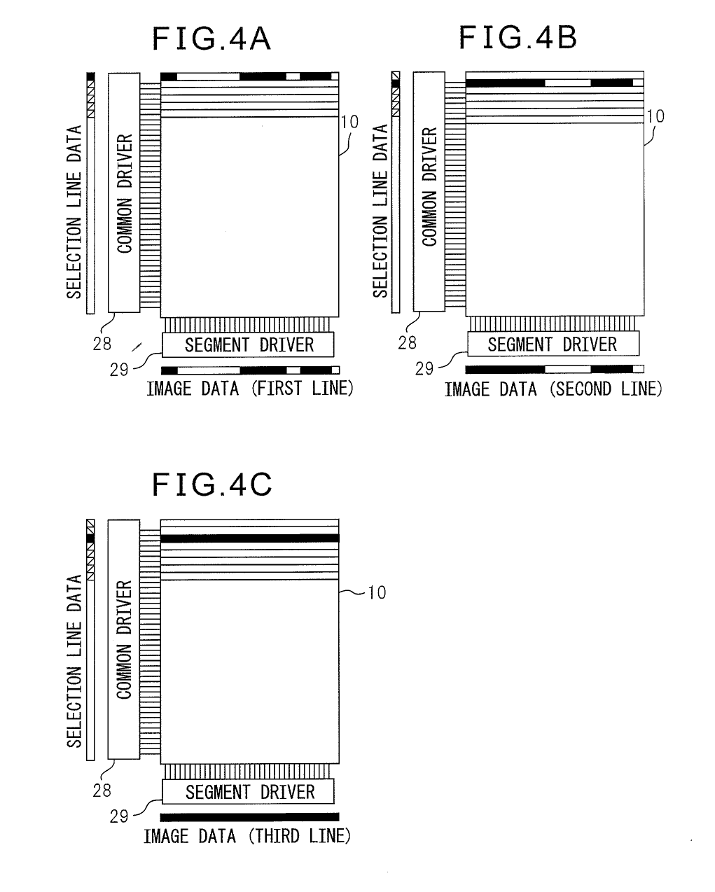

FIGS. 4A to 4C are diagrams explaining the scan operation in the dynamic drive system. The method of driving a flat panel display, such as a liquid crystal display device, includes the simple matrix method and TFT method. Usually, a cholesteric liquid crystal display device uses the simple matrix method from the viewpoint of the manufacturing cost, etc. In a display device that uses the simple matrix method, the scan electrode is driven by a common driver 28 and the data electrode is driven by a segment driver 29.

FIGS. 4A to 4C illustrate an example in which the preparation period and the evolution period the length of which is five times that of the selection period are provided before and after the selection period. FIG. 4A illustrates a case where the 0th line is the selection period. In this case, the first to fifth lines are the preparation period and lines other than the 0th to fifth lines are the non-select period. FIG. 4B illustrates a case where the first line is the selection period. In this case, the second to sixth lines are the preparation period, the 0th line is the evolution period, and lines other than the 0th to sixth lines are the non-select period. FIG. 4C illustrates a case where the second line is the selection period. In this case, the third to seventh lines are the preparation period, the 0th to first lines are the evolution period, and lines other than the 0th to seventh lines are the non-select period. In this configuration, write is performed while shifting the line of the selection period.

The preparation period and the evolution period before and after the selection period are in the state of a black display and it seems as if a black belt shifts. In the example described above, the length of the preparation period and the evolution period is assumed to be five times that of the selection period, however, in actuality, tens of times to one hundred times and while an image is being rewritten, it seems as if a thick black belt shifts.

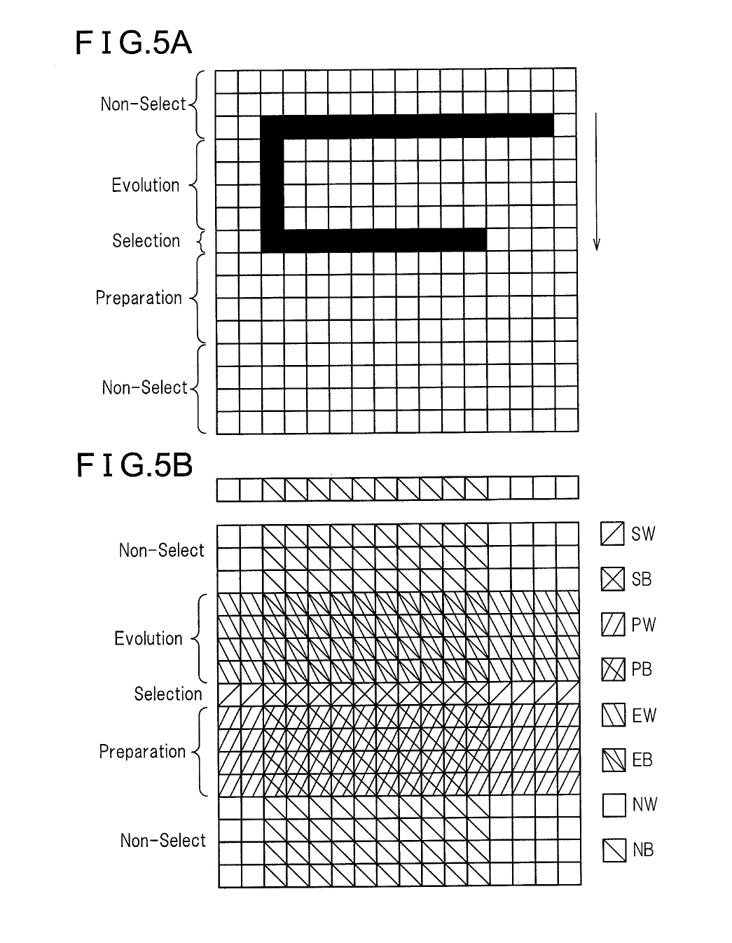

FIG. 5A is a diagram illustrating the way “F” is written. As illustrated in FIG. 5A, in the state where the line of the selection period advances on the way of writing “F”, the four lines of the preparation period and the four lines of the evolution period exist before and after the selection period and other lies are the non-select period. At this time, the segment driver 29 outputs a voltage signal corresponding to the image (black and white) data of the selection period.

FIG. 5B is a diagram illustrating a distribution of voltage waveforms applied to each pixel in the state in FIG. 5A. There are eight kinds of waveform applied to a pixel, that is, four kinds of output of the common driver 28 of the non-select period, the selection period, the evolution period, and the preparation period and two kinds of output of the white display and two kinds of output of the black display of the segment driver 29. These eight kinds of waveform are represented by NW (non-select and white), NB (non-select and black), SW (selection and white), SB (selection and black), EW (evolution and white), EB (evolution and black), PW (preparation and white), and PB (preparation and black). As illustrated in FIG. 5B, there are pixels to which the eight kinds of voltage waveform NW, NB, SW, SB, EW, EB, PW, PB are applied.

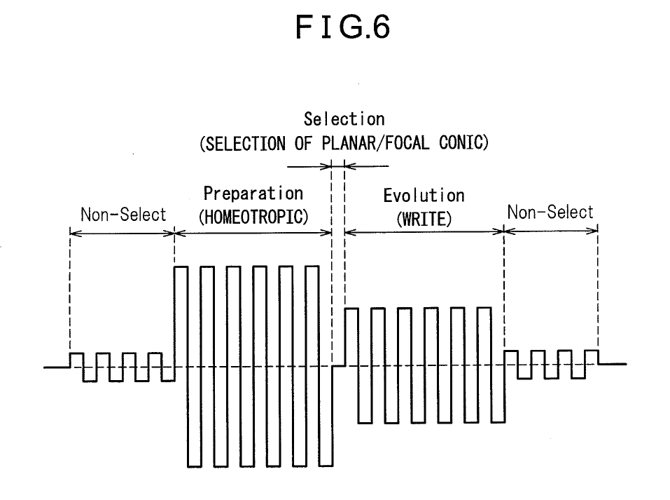

FIG. 6 is a diagram more specifically illustrating a voltage waveform applied to liquid crystal molecules. This voltage waveform is applied to each pixel in one scan line and the waveform of the selection period differs in accordance with image data. In a liquid crystal display device, it is common to apply a set of positive and negative pulses in order to prevent polarization of the liquid crystal and in FIG. 6 also, a set of positive and negative pulses is illustrated as an example.

In the dynamic drive system of cholesteric liquid crystal, the margin of conditions to determine whether to transition to the planar state or the focal conic state during the selection period is small, and therefore, the stability of a display (in particular, of an intermediate gradation) for the manufacture error of the panel and the ambient temperature is a problem.

In a cholesteric liquid crystal display device that uses the dynamic drive system, in order to produce a display of an intermediate gradation, the voltage signal applied during the selection period is changed.

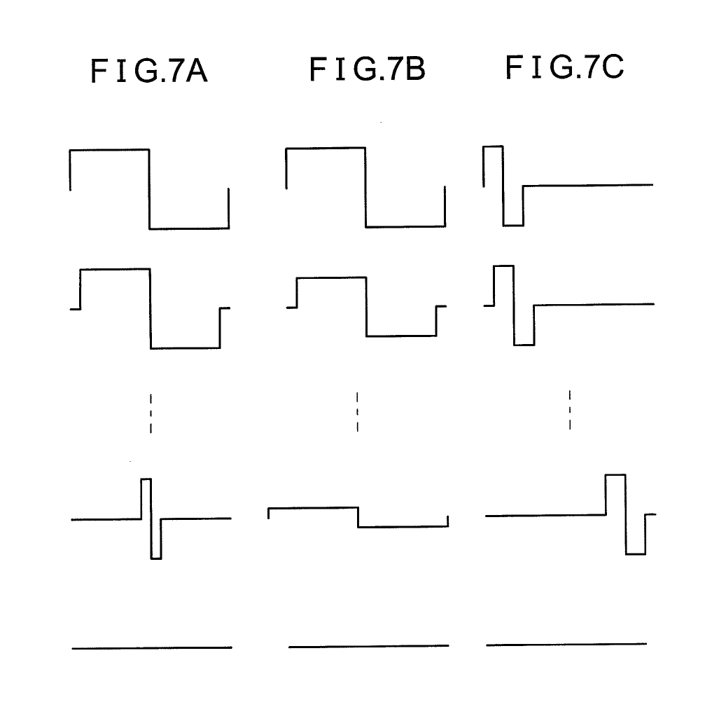

FIGS. 7A to 7C are diagrams illustrating examples in which the voltage signal applied during the selection period, that is, the selection pulse is changed when a display of an intermediate gradation is produced by the dynamic drive system.

FIG. 7A illustrates an example in which the width of the selection pulse is changed, called the PWM (pulse width modulation) system. The greatest width of the selection pulse corresponds to the white display and the white display changes toward the black display as the width of the selection pulse becomes narrower and the zero width of the selection pulse corresponds to the black display.

FIG. 7B illustrates an example in which the voltage of the selection pulse is changed, called the PAM (pulse amplitude modulation) system. The highest voltage of the selection pulse corresponds to the white display and the white display changes toward the black display as the voltage of the selection pulse becomes lower and the zero voltage of the selection pulse corresponds to the black display.

FIG. 7C illustrates an example in which the position of the selection pulse is changed, called the PPM (pulse position modulation) system. The position of the selection pulse nearest to the preparation period corresponds to the white display and the white display changes toward the black display as the position of the selection pulse becomes more distant from the preparation period and the position of the selection pulse most distant from the preparation period corresponds to the black display.

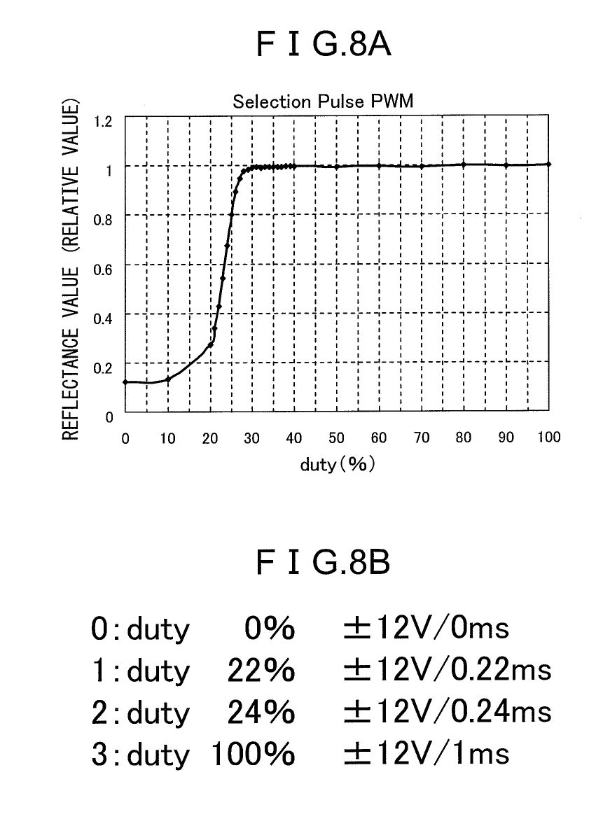

FIG. 8A is a diagram illustrating the change in display value when the width of the selection period is fixed and the width of the selection pulse, that is, the duty is changed. The reflection value is a relative value when the maximum reflectance is taken as 1 and positive and negative pulses of ±12 V are applied as the selection pulse. In other words, FIG. 8A illustrates the change in display luminance when the pulse width is changed in the PWM system illustrated in FIG. 7A in which the width of the pulse is changed.

As illustrated in FIG. 8A, when the duty is in the range of 10% to 30%, in particular, in the range of 20% to 30%, the reflection value changes rapidly and in order to produce a display of an intermediate gradation, the duty is changed in this range.

FIG. 8B illustrates the pulse widths when the duty is 0%, 22%, 24%, and 100%. At this time, the widths of the selection pulse are 0 ms, 0.22 ms, 0.24 ms, and 1 ms, and the reflection values are 0.12, 0.42, 0.68, and 1, respectively, and therefore, it is possible to display the luminance level in four values.

As illustrated in FIG. 8B, in order to produce a display of an intermediate gradation, it is necessary to accurately control 0.01 ms for 1 ms and very strict control of the width of the selection pulse is necessary. Further, the duty at which the reflection value changes shifts depending on the manufacture error of the panel and the ambient temperature, and therefore, there used to be such a problem that the stable display of an intermediate gradation is difficult to achieve.

As described above, the dynamic drive system has such a problem that the control of a display of an intermediate gradation is difficult to achieve although the high-speed drive may be achieved.

Embodiments are described below specifically with reference to the drawings.

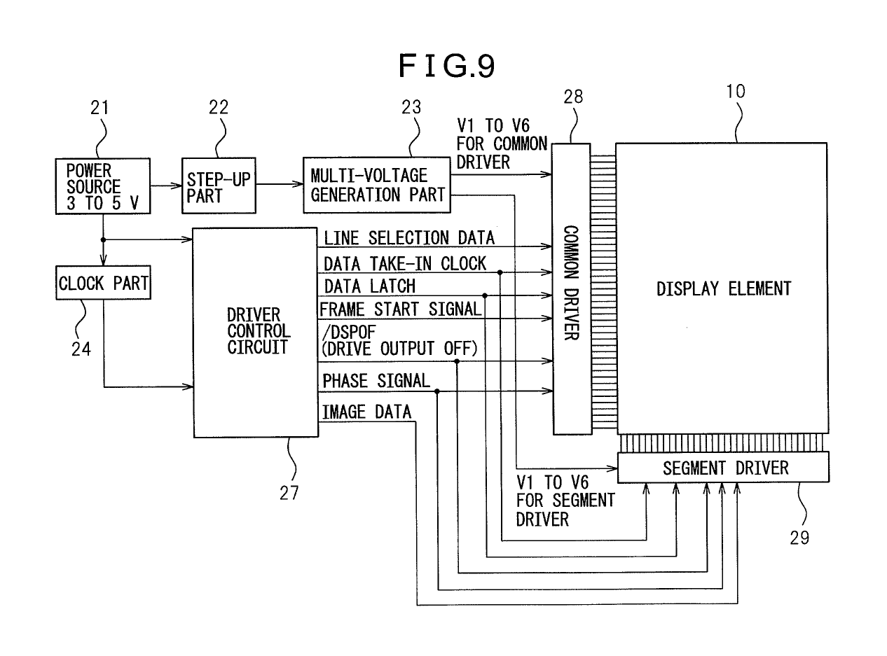

A first embodiment is described with reference to FIG. 9 to FIG. 16.

FIG. 9 is a block diagram illustrating a configuration of a cholesteric liquid crystal display device in the first embodiment.

The method of driving a flat panel display device such as a liquid crystal display device includes, for example, the simple matrix method and TFT method. Usually, a cholesteric liquid crystal display device uses the simple matrix method from the viewpoint of the manufacturing cost, etc., and the cholesteric liquid crystal display device in the first embodiment also uses the simple matrix method.

The cholesteric liquid crystal display device in the first embodiment includes a display element 10, a power source 21, a step-up part 22, a multi-voltage generation part 23, a clock part 24, a driver control circuit 27, the common driver 28, and the segment driver 29.

The power source 21 outputs a voltage of, for example, 3 V to 5 V. The step-up part 22 steps up a voltage input from the power source 21 to +36 V to +40 V by a regulator such as a DC-DC converter. The multi-voltage generation part 23 generates various voltages to be supplied to the common driver 28 and the segment driver 29 from the stepped-up voltage.

The clock part 24 generates a base clock on which the operation is based and generates various clocks necessary for the operation from the generated base clock.

The display element 10 is a display element in which, for example, three RGB cholesteric liquid crystal panels are laminated and which may produce a color display. The display element 10 complies with, for example, the A4 size XGA specifications and has 1,024×768 pixels. Here, 1,024 scan electrodes and 768 data electrodes are provided and the common driver 28 drives the 1,024 scan electrodes and the segment driver 29 drives the 768 data electrodes. The image data given to each pixel of RGB differs, and therefore, the segment driver 29 drives each data electrode independently. The common driver 28 commonly drives the RGB scan electrodes. It is assumed that the scan line corresponding to the scan electrode located at the uppermost part of the screen is the 0th line and the scan line corresponding to the scan electrode located at the lowermost part of the screen is the 1,023th line.

The control circuit 27 generates control signals based on the base clock, various clocks, and image data D and supplies them to the common driver 28 and the segment driver 29. Line selection data is data to specify a scan line between the preparation period, the selection period, and the evolution period to the common driver 28 and is 2-bit data here. The image data is data to specify a display of an intermediate gradation of each pixel and the segment driver 29 outputs a signal to be applied to each data electrode based on the image data. A data take-in clock is an image data transfer clock and the segment driver 29 internally transfers image data in synchronization with the image data transfer clock. A frame start signal is a signal to specify the start of data transfer of a display screen to be rewritten and the common driver 28 resets the interior in accordance with the frame start signal. A data latch signal is a signal to specify the termination of transfer of image data by the segment driver 29 and the segment driver 29 latches image data transferred in accordance with the signal. Further, the common driver 28 shifts one line at the same time as latching line selection data in accordance with the data latch signal. A driver output OFF signal /DSPOF is a forced OFF signal of an applied voltage. A phase signal is a signal obtained by equally dividing the selection period into four parts and the segment driver 29 controls whether or not to output (whether to turn ON or OFF) the selection pulse in each phase in accordance with image data and the common driver 28 repeats the same output four times in accordance with the phase signal.

FIG. 10 is a diagram illustrating the configuration of the display element 10 used in the first embodiment. As illustrated in FIG. 10, in the display element 10, three panels, that is, a blue panel 10B, a green panel 10G, and a red panel 10R are laminated in order from the viewing side and under the red panel 10R, a light absorbing layer 17 is provided. The panels 10B, 10G, and 10R have substantially the same configuration, however, the liquid crystal material and chiral material are selected and the content of the chiral material is determined so that the center wavelength of reflection of the panel 10B is blue (about 480 nm), that of the panel 10G is green (about 550 nm), and that of the panel 10R is red (about 630 nm). The scan electrode and data electrode of the panels 10B, 10G, and 10R are driven by the common driver 28 and the segment driver 29.

The panels 10B, 10G, and 10R have substantially the same configuration except in that the center wavelengths of reflection differ from one another. Hereinafter, a typical example of the panels 10B, 10G, and 10R is represented by a panel 10A and its configuration is explained.

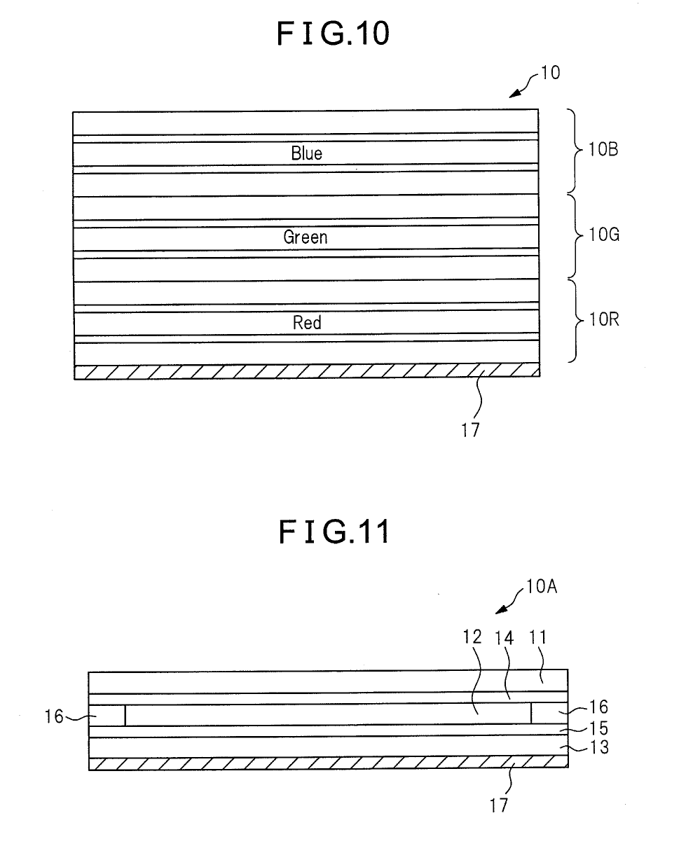

FIG. 11 is a diagram illustrating a configuration of the single panel 10A.

As illustrated in FIG. 11, the panel 10A has an upper side substrate 11, an upper side electrode layer 14 provided on the surface of the upper side substrate 11, a lower side electrode layer 15 provided on the surface of a lower side substrate 13, and a sealing material 16. The upper side substrate 11 and the lower side substrate 13 are arranged so that their electrodes are in opposition to each other and after a liquid crystal material is sealed in between, they are sealed with the sealing material 16. Within a liquid crystal layer 12, a spacer is arranged, however, it is not illustrated schematically. To the electrodes of the upper side electrode layer 14 and the lower side electrode layer 15, a voltage pulse signal is applied and thereby a voltage is applied to the liquid crystal layer 12. A display is produced by applying a voltage to the liquid crystal layer 12 to bring the liquid crystal molecules of the liquid crystal layer 12 into the planar state or the focal conic state. A plurality of scan electrodes and a plurality of data electrodes are formed in the upper side electrode layer 14 and the lower side electrode layer 15.

The panel configuration of a cholesteric liquid crystal display element is widely known, and therefore, further explanation is omitted.

There is manufactured a general-purpose STN driver as a product, which may be used both as a common driver and as a segment driver by setting the operation mode. In the first embodiment, the common driver 28 and the segment driver 29 are realized by the general-purpose STN driver.

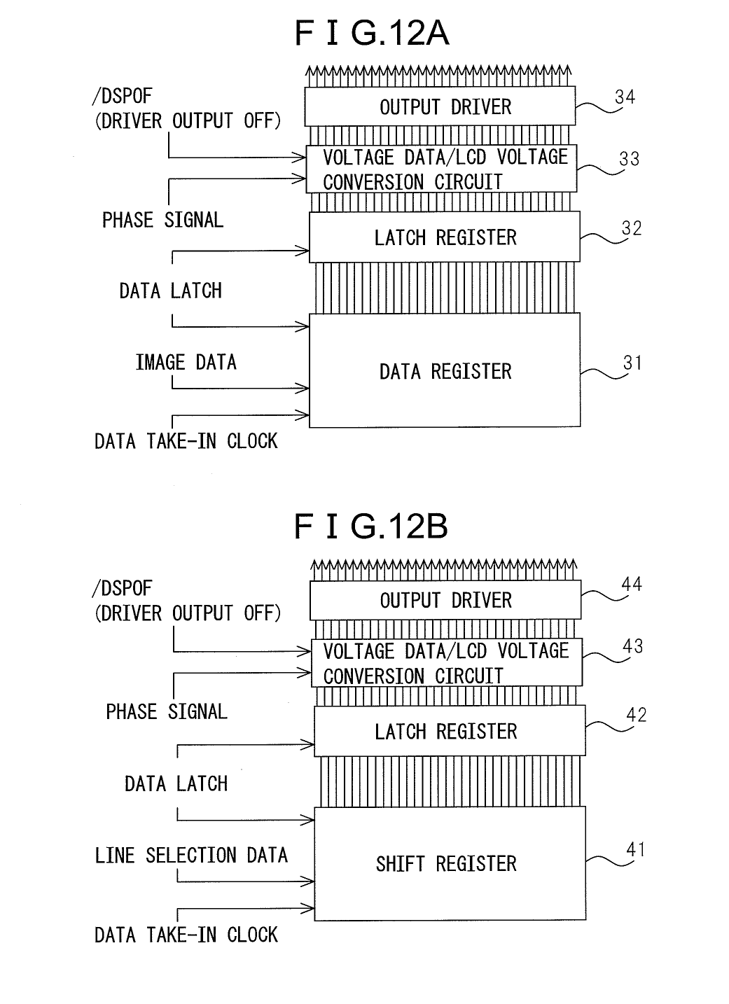

FIG. 12A illustrates the configuration of the segment driver 29 and FIG. 12B illustrates the configuration of the common driver 28.

The segment driver 29 includes a data register 31, a latch register 32, a voltage data/LCD voltage conversion circuit 33, and an output driver 34. The data register 31 takes in image data in accordance with a data take-in clock and shifts the stage one by one. The latch register 32 latches data corresponding to one line taken in by the data register 31 in accordance with a data latch signal. The data register 31 takes in image data corresponding to the next line while the latch register 32 outputs image data corresponding to one line. The voltage data/LCD voltage conversion circuit 33 generates a voltage applied to each data line in accordance with image data of each data line output from the latch register 32. The output driver 34 outputs the voltage output from the voltage data/LCD voltage conversion circuit 33 to each data line. Consequently, the data register 31, the latch register 32, the voltage data/LCD voltage conversion circuit 33, and the output driver 34 have outputs in the number corresponding to the number of data electrodes, that is 768 in the first embodiment, respectively.

In the first embodiment, image data includes O-bit intermediate gradation data. The voltage data/LCD voltage conversion circuit 33 produces an output by dividing it into four phases and produces the output of each phase in accordance with the 4-bit value of the intermediate gradation data of the image data.

The common driver 28 includes a shift register 41, a latch register 42, a voltage data/LCD voltage conversion circuit 43, and an output driver 44. The common driver 28 differs from the segment driver 29 in that the shift register 41 is provided in place of the data register 31 and that the common driver 28 has the outputs in the number corresponding to the number of scan electrodes, i.e., 1,024 in the first embodiment. Consequently, the data register 41, the latch register 42, the voltage data/LCD voltage conversion circuit 43, and the output driver 44 have 1,024 outputs, respectively. The shift register 41 resets the interior in accordance with a frame start signal, takes in line selection data in accordance with a data latch signal, and shifts the stage one by one. The latch register 42 latches the output of the shift register 41 in accordance with a data latch signal.

In the first embodiment, the voltage data/LCD voltage conversion circuit 43 repeatedly outputs the same pulse four times in accordance with a phase signal.

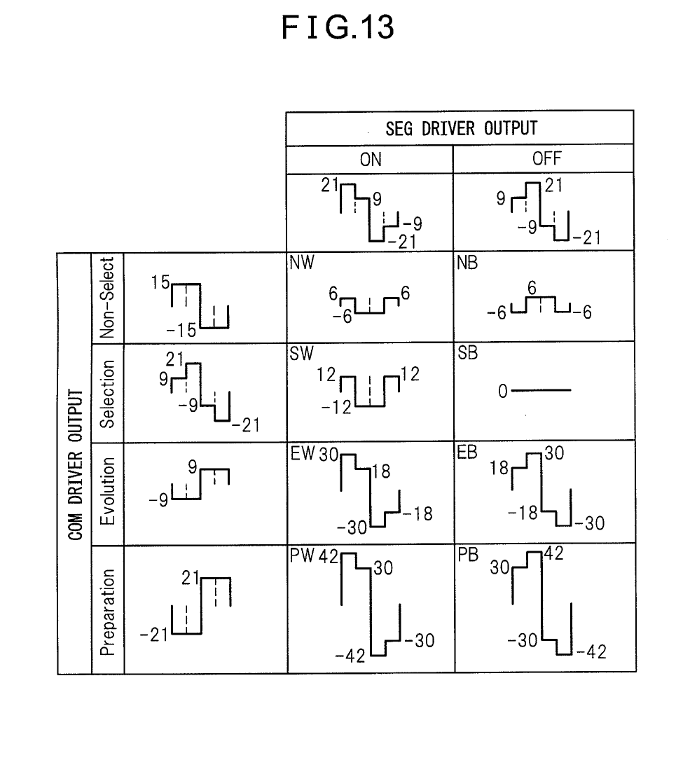

FIG. 13 illustrates drive waveforms the common driver 28 outputs during the preparation period, the selection period, the evolution period, and the non-select period, drive waveforms the segment driver 29 outputs for ON and OFF, and waveforms applied to the liquid crystal. The common driver 28 repeatedly outputs such drive waveforms for each phase specified by the phase signal. The segment driver 29 outputs a drive waveform of ON or OFF in accordance with each bit value of the intermediate gradation data of the image data for each phase. Consequently, as described previously, the waveforms applied to a pixel include eight kinds of output, that is, the four kinds of output of the common driver 28 during the non-select period, the selection period, the evolution period, and the preparation period and two kinds of output of the white display and the black display, respectively, of the segment driver 29. As described previously, these eight kinds of waveform are represented by NW (non-select and white), NB (non-select and black), SW (selection and white), SB (selection and black), EW (evolution and white), EB (evolution and black), PW (preparation and white), and PB (preparation and black).

In the first embodiment, the common driver 28 and the segment driver 29 change the output in units of cycles obtained by further equally dividing the phase obtained by equally dividing the selection period. The cycle is specified by a cycle signal, not illustrated schematically.

The common driver 28 outputs, for example, a drive waveform that changes to +15 V, +15 V, −15 V, −15 V in four cycles during the non-select period and during the selection period, a drive waveform that changes to +9 V, +21 V, −9 V, −21 V in four cycles. Further, the common driver 28 outputs a drive waveform that changes to −9 V, −9 V, +9 V, +9 V in four cycles during the evolution period and during the preparation period, a drive waveform that changes to −21 V, −21 V, +21 V, +21 V in four cycles.

The segment driver 29 output, for example, a drive waveform that changes to +21 V, +9 V, −21 V, −9 V in four cycles when ON and when OFF, a drive waveform that changes to +9 V, +21 V, −9 V, −21 V in four cycles.

Due to this, the eight kinds of voltage waveform as illustrated in FIG. 13 are applied in accordance with the state of each pixel. The waveform of EW and EB is, for example, a waveform that is an approximation of a pulse of ±24 V and the waveform of PW and PB is, for example, a waveform that is an approximation of a pulse of ±36 V.

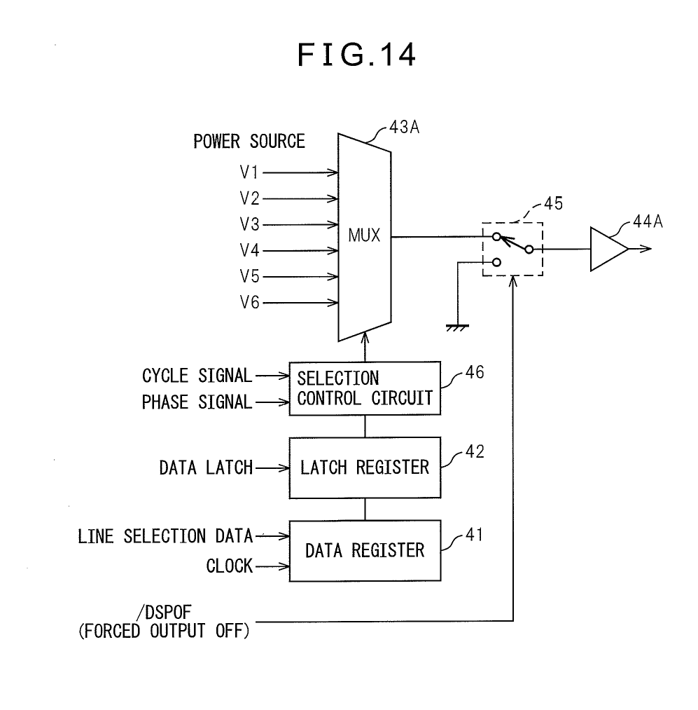

FIG. 14 is a diagram illustrating configurations of parts corresponding to the voltage data/LCD voltage conversion circuit 43 in the common driver 28 and one scan electrode of the output driver 44. The voltage data/LCD voltage conversion circuit 43 includes a selection control circuit 46, an analog/multiplexer (MUX) 43A, and a switch 45. The selection control circuit 46 generates selection data from line selection data output from the latch register 42 in accordance with a phase signal and a cycle signal. The MUX 43A selects one voltage from among the six kinds of voltage V1 to V6 in accordance with selection data. V1 to V6 correspond to any of ±9 V, ±15 V, ±21 V.

For example, the selection control circuit 46 generates selection data to select 9 V for “0” cycle, 21 V for “1” cycle, −9 V for “2” cycle, and −21 V for “3” cycle during the selection period and repeats this selection signal during the four phases.

The switch 45 switches so that the signal supplied to a driver 44A is turned to the ground GND when the /DSPOF signal is valid (/DSPOF=“0”) and the output of the MUX 43A is supplied to the output driver 44A when the /DSPOF signal is invalid (/DSPOF=“1”). The output driver 44 has the driver 44A.

The voltage data/LCD voltage conversion circuit 43 and the output driver 44 have the sets of the MUX 43A, the switch 45, and the driver 44A in the number corresponding to the number of scan electrodes, that is, 1,024 sets.

The voltage data/LCD voltage conversion circuit 33 and the output driver 34 of the segment driver 29 have substantially the same configuration as that illustrated in FIG. 14, however, the selection control circuit 46 is different. In the segment driver 29, the selection control circuit outputs the ON drive waveform in FIG. 13 in the ON phase and outputs the OFF drive waveform in FIG. 13 in the OFF phase.

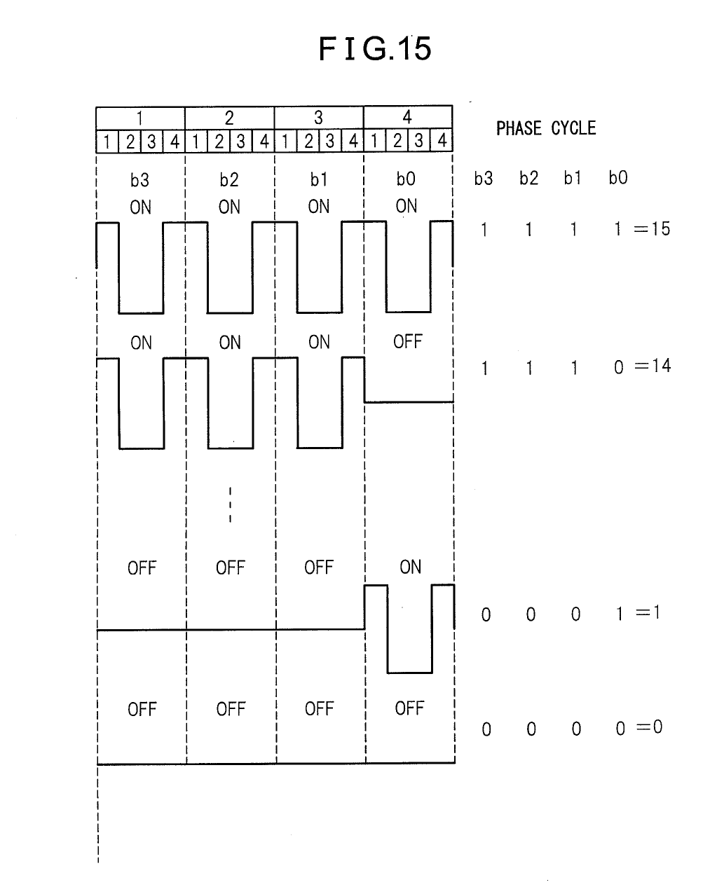

FIG. 15 is a diagram illustrating the configuration of a pulse applied to each pixel during the selection period in the first embodiment. The selection period is equally divided into four phases and the four phases correspond to b3 to b0 bits and in the case of the white display (ON), the voltage waveform of SW (selection and white) in FIG. 13 is applied and in the case of the black display (OFF), the voltage waveform of SB (selection and black) is applied in each phase. The values of b3 to b0 are “1” at the time of ON and “0” at the time of OFF and the pattern values of “0” to “15” are represented by combinations of b3 to b0. For example, the pattern value is “15” when all the values of b3 to b0 are “1”, “14” when the values of b3 to b1 are “1” and the value of b0 is “0”, “1” when the values of b3 to b1 are “0” and the value of b0 is “1”, and “0” when all the values of b3 to b0 are “0”.

Image data includes ON/OFF data (4 bits) of b3 to b0. The segment driver 29 outputs the voltage waveform of the black display when “0” and outputs the voltage waveform of the white display when “1” in accordance with “0” and “1” of b3 to b0 in the four phases. In response to this, the common driver 28 repeatedly outputs the voltage signal during the selection period in FIG. 13 for each phase. Due to this, it is possible to apply 16 kinds of voltage waveform by performing ON/OFF control of four pulses during the selection period.

Consequently, in the first embodiment, to each scan line (each pixel), a string of the non-select pulse, the preparation pulse, the selection pulse, the evolution pulse, and the non-select pulse is applied as illustrated in FIG. 6. Then, each pulse of the non-select pulse, the selection pulse, and the evolution pulse is a pulse in which the pulse illustrated in FIG. 13 is repeated four times and the selection pulse is one of the 16 kinds of pulse (including GND of “0”) illustrated in FIG. 15.

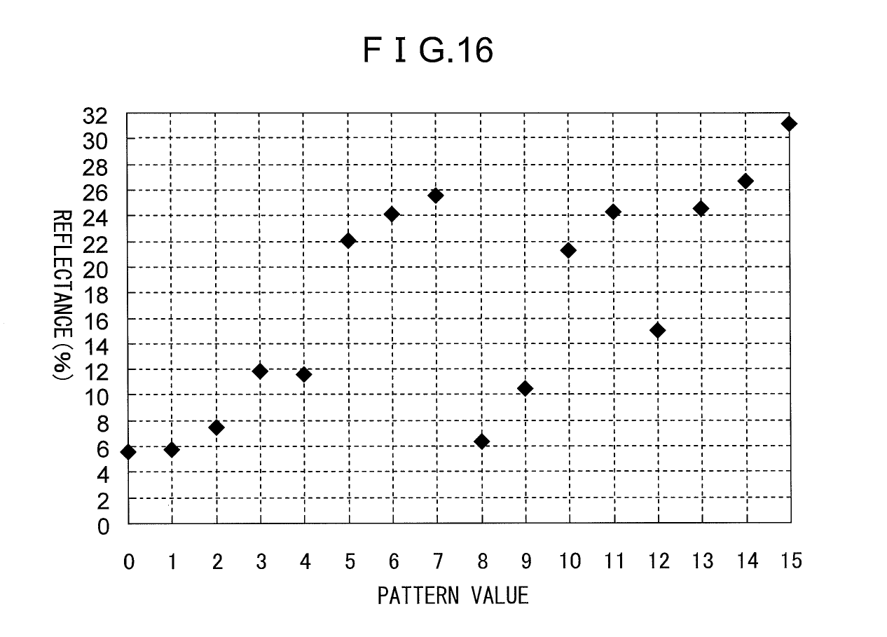

FIG. 16 is a diagram illustrating the reflection characteristics of a display when 16 kinds of voltage waveform are applied during the selection period in the first embodiment, wherein the horizontal axis represents the pattern value of “0” to “15” represented by combinations of b3 to b0 and the vertical axis represents the reflectance.

Since a reflectance of about 6% to 32% may be obtained in accordance with the pattern value, it is possible to determine a pattern value suitable for a four-gradation display by selecting any of the four pattern values. For example, the pattern values “15”, “10”, “12”, “0” are used as the pattern values of the four-gradation display and “0” gradation is caused to correspond to the pattern value “0”, “1” gradation to “12”, “2” gradation to “10”, and “3” gradation to “15”. When transferring gradation data as image data, the pattern values “0”, “12”, “10”, and “15” are input to the segment driver 29.

Next, a simple matrix display device in a second embodiment is explained.

The simple matrix display device in the second embodiment differs from the simple matrix display device in the first embodiment only in the configuration of the pulse applied to each pixel during the selection period and other parts are the same.

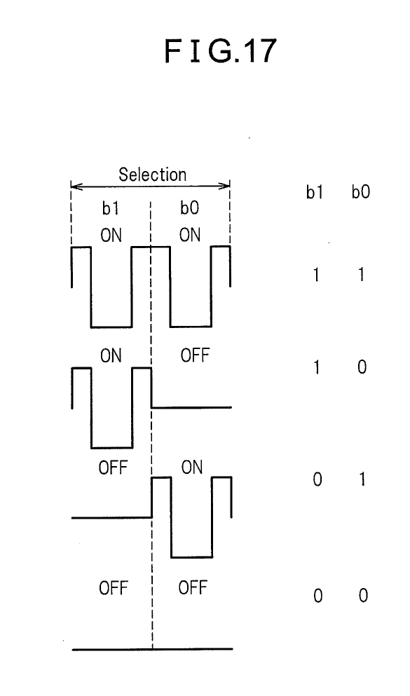

FIG. 17 is a diagram illustrating the configuration of the pulse applied to each pixel during the selection period in the second embodiment.

In the first embodiment, the selection period is equally divided into four phases, however, in the second embodiment, it is divided into two phases.

In FIG. 17, pattern values “0”, “3”, “12”, and “15” may represent four gradation values. The ON/OFF values of the four phases of the pattern values “0”, “3”, “12”, and “15” are “0000”, “0011”, “1100”, and “1111”. When the patter values are selected as described above, it is possible to represent four gradation values by 2 bits, and therefore, the number of pulses constituting the selection period may be reduced and the control may be simplified.

In the second embodiment, the two phases correspond to the bits of b1 and b0 and in the case of the white display (ON), the voltage waveform of SW (selection and white) in FIG. 13 is applied and in the case of the black display (OFF), the voltage waveform of SB (selection and black) is applied in each phase. The value of b1 and b0 is “1” when ON and “0” when OFF and pattern values “0” to “3” are represented by combinations of b1 and b0. For example, the pattern value is “3” when b1 and b0 are “1, 1”, “2” when b1 and b0 are “1, 0”, “1” when b1 and b0 are “0, 1”, and “0” when b1 and b0 are “0, 0”.

Image data includes ON/OFF data (2 bits) of b1 and b0. The segment driver 29 outputs the voltage waveform of the black display when “0” and outputs the voltage waveform of the white display when “1” in accordance with “0” and “1” of b1 and b0 in the two phases. In response to this, the common driver 28 repeatedly outputs the voltage signal during the selection period in FIG. 13 for each phase. Due to this, it is possible to apply four kinds of voltage waveform by performing ON/OFF control of two pulses during the selection period.

Next, a simple matrix display device in a third embodiment is explained.

The simple matrix display device in the third embodiment differs from the simple matrix display device in the second embodiment only in the configuration of the pulse applied to each pixel during the selection period and other parts are the same.

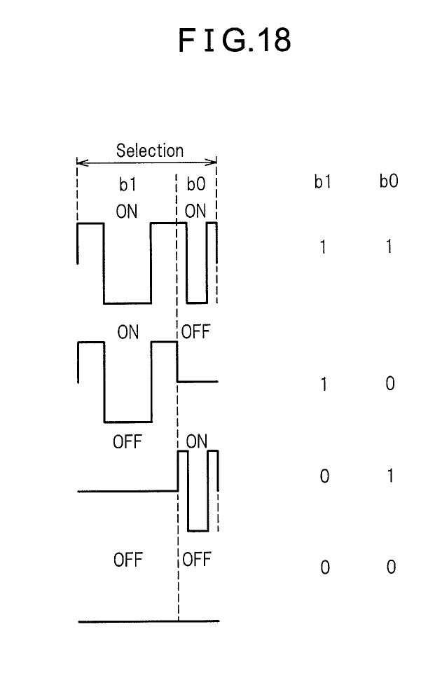

FIG. 18 is a diagram illustrating a configuration of a pulse applied to each pixel during the selection period in the third embodiment.

In the second embodiment, the selection period is divided into two phase of equal length. In the third embodiment, the selection period is divided into two phases, however, their lengths are different. Due to this, it is possible to more accurately control intermediate gradations in accordance with the characteristics of the cholesteric liquid crystal display element 10.

As above, the first to third embodiments are explained, however, there may be various modified examples. For example, in the first to third embodiments, the display element 10 is a display element in which the three cholesteric liquid crystal panels of RGB are laminated and capable of producing a color display, however, it is also possible to apply the configurations in the first to third embodiments to a display element having one cholesteric liquid crystal panel and which produces a monochrome display.

Further, in the first to third embodiments, the scan electrodes of the three cholesteric liquid crystal panels of RGB are commonly driven by the common driver 28, however, it is also possible to provide the common driver 28 for each panel and to drive the scan electrodes of the three panels independently of one another. In this case, it may also be possible to make different the configurations of pulses applied to each pixel during the selection period from each other at least between two display panels. Specifically, it may also be possible to make different the numbers of the selection pulses (numbers of phases) included in the selection period, or make different the lengths of the selection pulses (lengths of phases), or make both the numbers of the selection pulses and the lengths different from each other at least between two display panels.

As described above, in the display devices of the first to third embodiments, a control of a display of an intermediate gradation of a display element is facilitated and it is made possible to accurately produce a display of an intermediate gradation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of driving a display element including the steps of:
changing an orientation state of liquid crystal into a first orientation state;
changing the first orientation state into a second orientation state by combinations of a plurality of pulses in accordance with gradation data of an image to be displayed; and
maintaining the second orientation state.

2. The method according to claim 1, wherein
the combinations of the plurality of pulses are generated by ON/OFF control of a predetermined voltage.

3. The method according to claim 1, wherein
the plurality of pulses includes pulses of different widths.

4. The method according to claim 1, wherein
the display element comprises a plurality of display panels having different reflection center wavelengths, and
the plurality of pulses applied to the plurality of display panels respectively includes different pulse widths in at least two of the display panels.

5. The method according to claim 1, wherein
the display element comprises a plurality of display panels having different reflection center wavelengths, and
the plurality of pulses applied to the plurality of display panels respectively includes different numbers of pulses in at least two of the display panels.

6. A display device comprising:
a display element; and
a drive circuit that drives the display element, wherein
the drive circuit outputs:
a reset pulse that changes an orientation state of liquid crystal into a first orientation state;
a selection pulse that changes the first orientation state into a second orientation state by combinations of a plurality of pulses in accordance with gradation data of an image to be displayed; and
a maintenance pulse that maintains the second orientation state.

7. The display device according to claim 6, wherein
the combinations of the plurality of pulses are generated by ON/OFF control of a predetermined voltage.

8. The display device according to claim 6, wherein
the plurality of pulses includes pulses of different widths.

9. The display device according to claim 6, wherein
the dive circuit comprises:
a common driver that drives a scan electrode of the display element; and
a segment driver that drives a data electrode of the display element, wherein
the segment driver performs ON/OFF control of the plurality of pulses in accordance with a phase signal corresponding to the period of the plurality of pulses, and
the common driver repeatedly produces the same output in accordance with the phase signal during write of one line.

10. The display device according to claim 6, wherein
the display element comprises a plurality of display panels having different reflection center wavelengths, and
the plurality of pulses applied to the plurality of display panels respectively includes different pulse widths in at least two of the display panels.

11. The display device according to claim 6, wherein
the display element comprises a plurality of display panels having different reflection center wavelengths, and
the plurality of pulses applied to the plurality of display panels respectively includes different numbers of pulses in at least two of the display panels.
